(19) United States
(12) Patent Application Publication
(10) Pub. No.: US 2019/0383037 A1
(43) Pub. Date: Dec. 19, 2019

(54) A PLASTERING MACHINE, PARTICULARLY FOR APPLICATION OF THIN LAYERS OF A CEMENTITIOUS MATERIAL TO A BUILDING SURFACE, AND A MOUTHPIECE THEREFOR

(71) Applicant: Faster Plaster ApS, Thisted (DK)

(72) Inventor: Hans KLOSTER, Thisted (DK)

(73) Assignee: Faster Plaster ApS, Thisted (DK)

(21) Appl. No.: 16/335,228

(22) PCT Filed: Apr. 19, 2017
(86) PCT No.: PCT/EP2017/059274

§ 371 Date: Mar. 20, 2019

(30) Foreign Application Priority Data
Apr. 19, 2016 (DK) PA201670241

(51) Int. Cl. E04F 21/08; B05C 17/00

(52) U.S. Cl. CPC E04F 21/08; B05C 17/002

(57) ABSTRACT

The invention relates to a plastering machine (10) for applying a surface coating layer to a building surface (1), such as to a building wall (1), comprising a coating material supply (20) connected to a mouthpiece (30) via a conduit, said mouthpiece (30) having a top portion (T) and a bottom portion (B) and including a rear wall (31), a first side wall (31′) and a second side wall (31″) opposite said first side wall (31′), said rear wall (31) being connected to or integral with said first side wall (31′) and said second side wall (31″) to define a coating material recess (8) for containing coating material supplied to said mouthpiece through said conduit (15), said recess (8) preferably tapering in a direction from said top portion (T) to said bottom portion (B), said rear wall (31) having a lower edge (37) at said bottom portion (B), said first and second side walls (31′, 31″) each having one or more faces (SF) configured for being placed against said building surface (1) when applying said coating material contained in said recess (8) to said building surface (1). The lower edge (37) is configured for being placed against said building surface (1) together with said faces (SF) in use of said machine when applying said coating material contained in said recess (8) to said building surface (1), an elongated flexible seal (300) connected to each side wall (31′, 31″) extending between said bottom portion (B) and said top portion (T), for being placed against said building surface (1) when applying said coating material contained in said recess (8) to said building surface (1).

### FIELD OF THE INVENTION

The present invention relates i.a. to plastering machines for applying a surface coating, such as an aggregate cementitious surface coating, to a building structure, in particular to the surface of an exterior or interior building wall.

### BACKGROUND OF THE INVENTION

It is known to form an exposed building surface finish by applying cementitious slurry in a trowelling procedure using a handheld trowel connected to a slurry supply via a hose, see by way of example CA patent 1135572, US 2014/0057059 and U.S. Pat. No. 3,319,283.

Also, automated procedures involving plastering machines with floor mounted frames supporting mouthpieces have been developed. Illustrative examples of such plastering machines are disclosed in WO2012028156, FR 1 211 570 and CN patent 2506728.

Tools for the particular procedure with which the present invention is concerned differ fundamentally in size and operation from tools for filling joints and minor depressions in wall boards, such as the tool disclosed in U.S. Pat. No. 2,711,098 which is designed to be held with one hand using a handle with an internal conduit for supplying mastic to an applicator mouthpiece.

When applying a coating material to a building surface it is important to ensure a substantially uniform thickness of the resulting coating. Where a frame supporting a mouthpiece and arranged at a certain fixed position from a building wall is used, as in the aforementioned WO2012028156, FR 1 211 570 and CN patent 2506728 publications, this leads to problems where the building wall is not completely vertical. Likewise, where a handheld trowel as illustrated in CA patent 1135572 is used great skills are required as the worker must manually maintain the mouthpiece at a certain distance from the wall surface.

U.S. Pat. No. 3,319,283, upon which the preamble of claim 1 is based, shows a plastering machine with a handheld mouthpiece with faces for being placed against the work surface. This prior art mouthpiece is for applying a relatively thick coating layer and is disadvantageous in that the elongated runners have a plane edge that will follow irregularities in the working surface as the mouthpiece is moved. Thus, where the runners locally contact discrete raised points typical in rough building surfaces the mouthpiece will rock slightly, giving rise to variations in the distance between the lower edge of the mouthpiece and the building surface. Such variations bring about corresponding variations in the thickness of the coating layer applied to the building surface. Hence, the plastering machine of U.S. Pat. No. 3,319,283 is not suitable for applying coating material where there is a desire to still be able to distinguish the texture of the building surface, in particular where the thickness of the layer is very small. Where slurries of low viscosity are applied there is also a significant risk that the slurry may escape the mouthpiece along the runners in use of the machine.

Thus, with any of the aforementioned tools there are practical problems which are believed to be the cause of builders tending to prefer reliance on the conventional hard work and inefficient procedures where very thin coatings are applied using a trowel dipped in a plaster containing bucket and then used to manually transfer plaster to the building wall surface.

### BRIEF SUMMARY OF THE INVENTION

The object of the present invention is to provide a plastering machine, and a mouthpiece therefor, which is suitable for applying a thin coating of substantially uniform thickness, in particular of a low viscosity fine grain cementitious coating material, onto a building wall, in particular a brick wall, and which at the same time alleviates the hard work involved in the conventional trowelling procedures. Such thin material layers are often applied where there is a desire to allow a viewer to visually distinguish the texture of the bricks.

This is achieved by a plastering machine further including the features defined in the characterising clause of claim 1 where the lower edge of the rear wall in use is for being placed against the building surface. To allow for the mouthpiece to even better follow the contour of the building surface the mouthpiece may have faces arranged as defined in claim 2. To allow for an efficient sealing of the mouthpiece against the building structure surface the machine may have a seal formed as defined in claims 3 and 4. To ease handling of the mouthpiece flanges may be provided in accordance with claim 6, allowing for the provision of large surface face faces, and a handle as defined in claim 7 may conveniently be provided, preferably being connected to the aforementioned flanges allowing a user to reliably press the mouthpiece against the building surface. Highly convenient a connector as defined in claim 9 may be provided, whereby kinking of a flexible supply hose may be avoided.

Further favourable embodiments are defined in the dependent claims.

The flexible seal preferably is formed from an elastic material, such as an elastomeric material or a foamed material, whereby the seal yields locally elastically as it is passed over local irregularities in the building surface, to maintain or essentially maintain is high degree of sealing, thereby restricting or preventing undesired loss of slurry in the plaster material chamber defined together by the mouthpiece and the building surface.

Embodiments of the invention will now be described, by way of example only, with reference to the accompanying drawings, as follows:

FIG. 1 is a perspective view of a plastering machine according to the invention,

FIG. 2 is a perspective view of a mouthpiece of the machine of FIG. 1 placed against a brick building wall,

FIG. 3 is a front perspective view of the mouthpiece of the plastering machine of FIG. 1,

FIG. 4 is another perspective view of the mouthpiece,

FIG. 5 is a rear perspective view of the mouthpiece of FIG. 3,

FIG. 6 is a perspective view of a hollow portion of the conduit leading material to the mouthpiece,

FIG. 7 is a cross-sectional view of the portion shown in FIG. 6,

FIG. 8 is a view similar to FIG. 3, showing the mouthpiece in another configuration,

FIG. 9 is a view similar to FIG. 5, showing the hollow portion of FIG. 6 in another configuration,

FIGS. 10-12 show the mouthpiece in various configurations, during connection of the hollow portion of FIG. 6, and

FIGS. 13 and 14 show an embodiment of the mouthpiece 30 wherein the lower edge is serrated, FIG. 13 showing the pattern of a coating material, which may be glue, deposited on the building surface 1 using such a mouthpiece.

### BRIEF DESCRIPTION OF THE DRAWINGS

FIG. 1 shows schematically a building wall 1, such as a brick wall, in the process of having a part of its surface being covered with a first or initial run 5 of a coating material, using the plastering machine 10 of the present invention. While for illustrative purposes the applied run 5 is shown herein as being a relatively thick layer of plaster/slurry the invention is normally for applying very thin layers, preferably of a relatively low viscosity cementitious material, having a thickness allowing a viewer to distinguish the “texture” of the building wall, eg. allowing a viewer to distinguish the individual bricks forming the building wall 1. This effectively is achieved by having a lower edge of the mouthpiece scraping against or wiping the irregular or rough building surface onto which the coating material is normally applied, the irregularities being filled out and the mortar joints between the bricks also being filled out to some extent.

The plastering machine 10 comprises a coating material pump 20, preferably configured for being positioned on a base near the building wall 1, a conduit including a flexible hose 15, and a work-piece in the form of a mouthpiece 30 which is connected to the conduit and to which is rigidly connected a handle 39 allowing a worker (not shown) with his hands to hold the mouthpiece 30 firmly against the surface of the building wall 1. The mouthpiece has a top portion T and a bottom portion B closer to the base. Normally, the mouthpiece 30 will be of metal or a sturdy plastic material.

By holding the mouthpiece 30 firmly against the wall 1, and through the design of the mouthpiece 30, to be discussed further below, it is ensured that during the coating procedure substantially no coating material will leave the mouthpiece in a sideway direction perpendicular to the extension of the run 5.

On activation of the pump 20 coating material, in the following for simplicity referred to as “plaster”, is delivered from the pump 20 via the aforementioned conduit to a plaster material chamber 8′ defined together by the building wall 1 and the mouthpiece 30, see FIG. 2 wherein portions of the mouthpiece 30 are shown as being transparent for illustrative purposes only. By continuously moving the mouthpiece 30 in an upward direction until reaching the upper edge of the surface of the building wall 1, which may be defined by a building ceiling (not shown), the run 5 of plaster is deposited onto the building wall 1, the width of the run 5 corresponding to the length of a lower edge 37 of a rear wall 31 of the mouthpiece 30 at the lower portion thereof, as will be explained. As seen best in FIG. 4 the lower edge 37 may be straight, and may be defined by a replacement part 600 (compare FIGS. 3 and 4) mountable by screws (not shown) or otherwise to form a part of the rear wall 31; this option is of benefit since the lower edge 37 will normally be subject to wear when scraping against the building surface 1, as shown in FIG. 2.

FIG. 3 shows the mouthpiece 30 in greater details; a rear wall 31 of the mouthpiece 30, in use of the machine being closest to the worker, defines in part a recess 8 closed by the building wall 1 to define the aforementioned material chamber 8′. Connected to the rear wall 31 are a first side wall 31′ and an opposite second side wall 31″, seen best in FIG. 4, defining also in part the chamber 8′. Opposite the bottom portion B of the mouthpiece 30, at the top portion T thereof, is an inspection opening 36 bounded by a top flange 35 and a top edge of the rear wall 31, allowing the worker to see the level of material inside the chamber 8′. The top flange 35 may extend to some extent towards the lower edge 37, to delimit the chamber 8′ in a part thereof closest to the building wall 1. The rear wall 31 is preferably plane and preferably inclined such that the recess 8 tapers in a direction from the top portion T to the bottom portion B, i.e. such that the width of the material chamber 8′ measured perpendicularly to the building surface 1 preferably varies linearly.

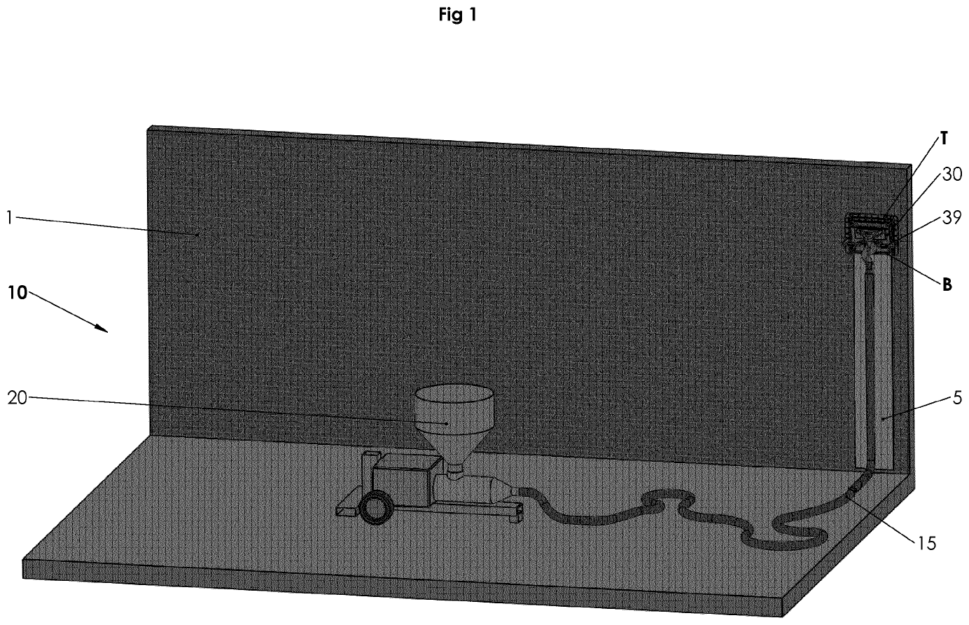

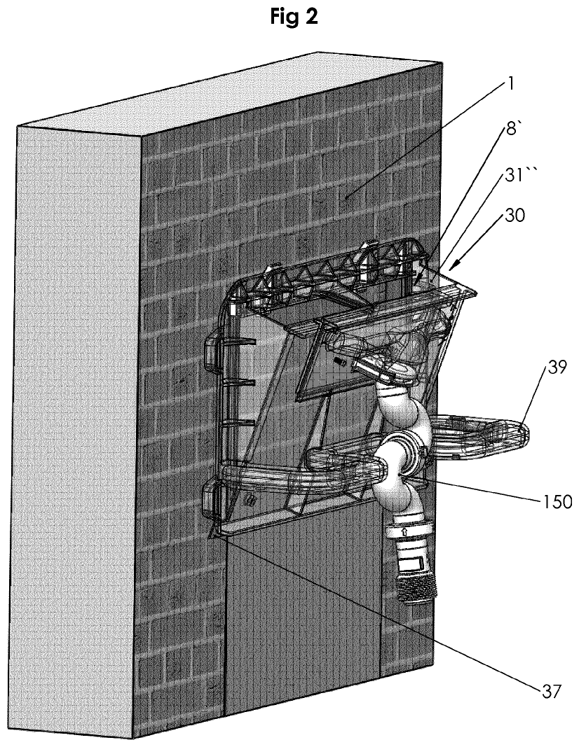

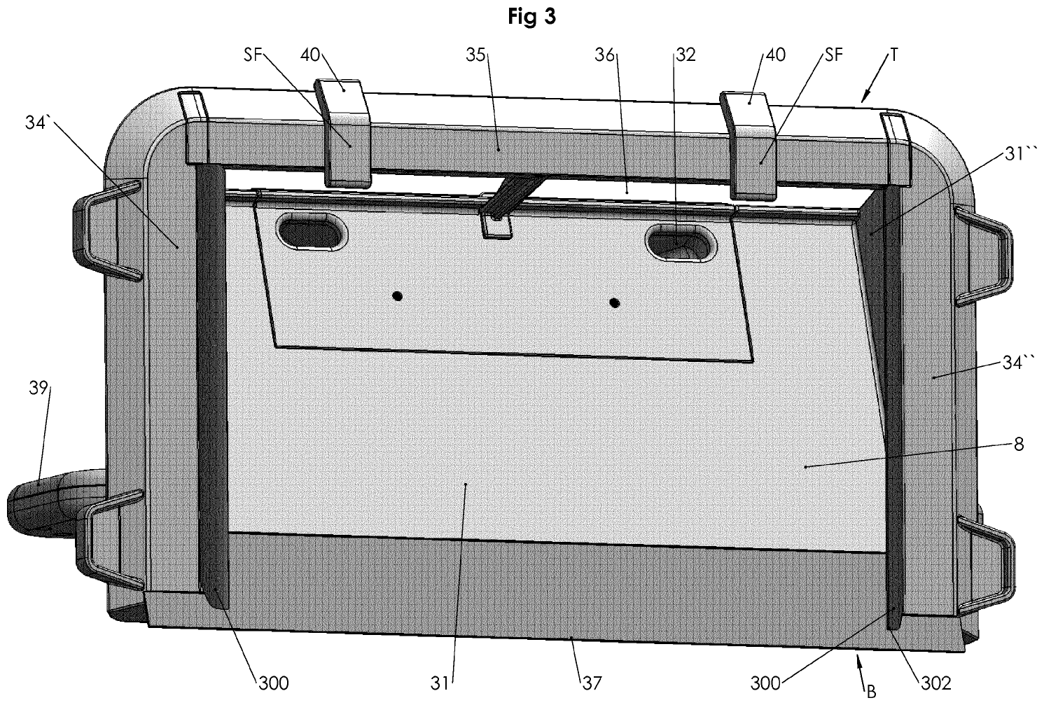

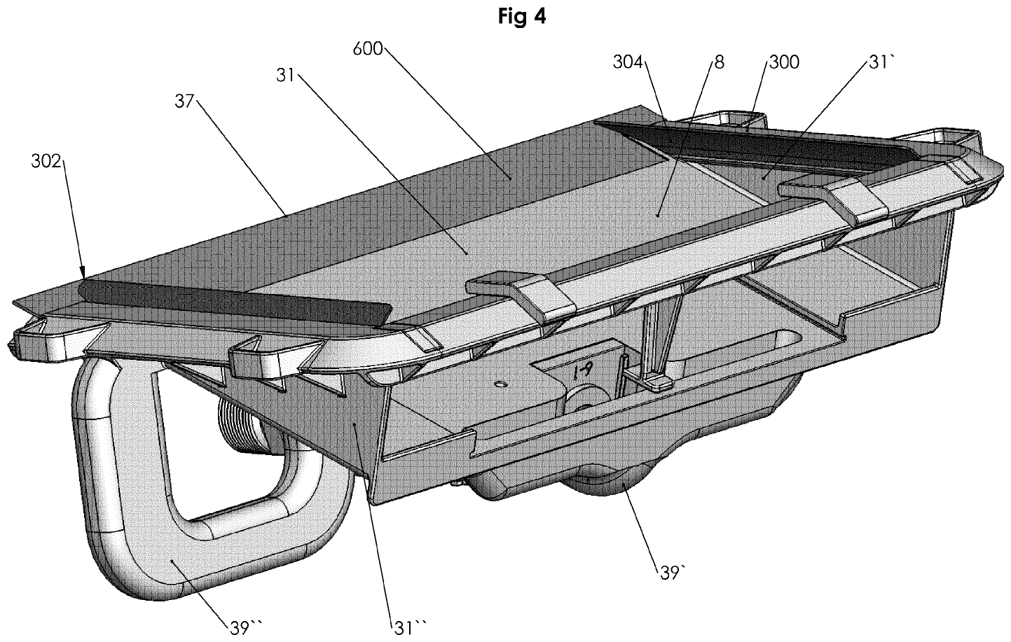

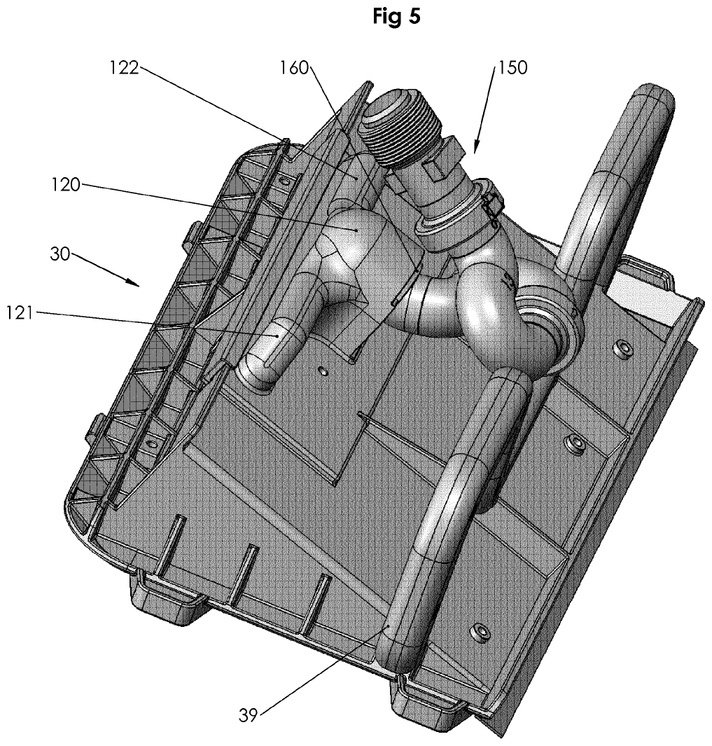

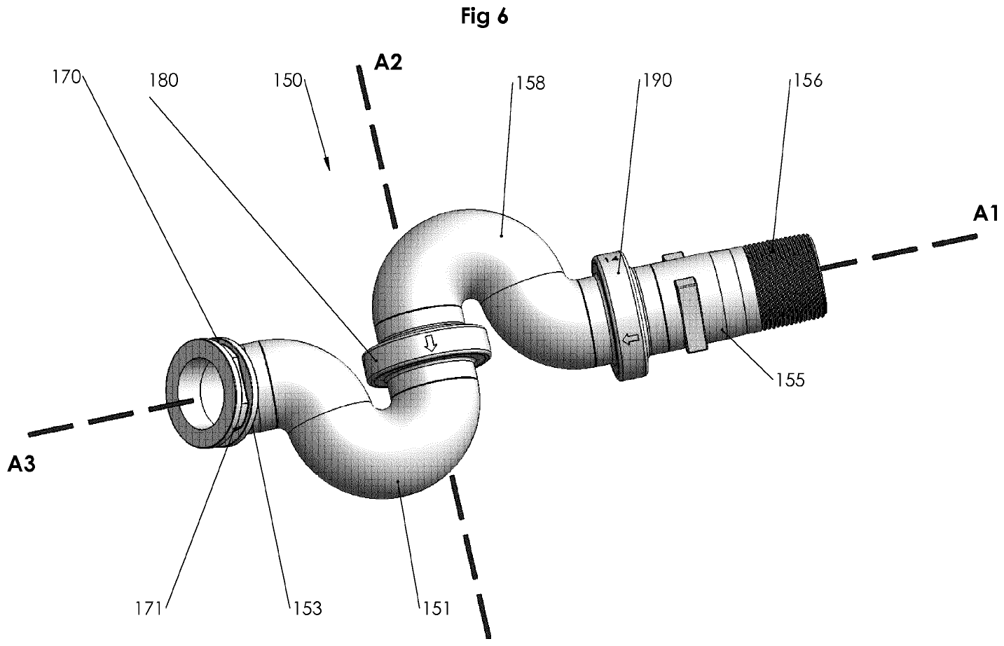

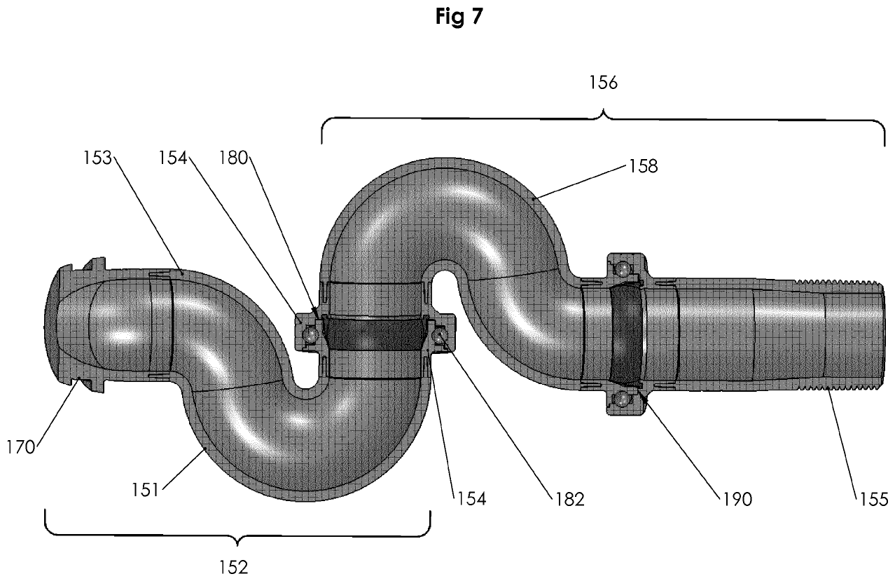

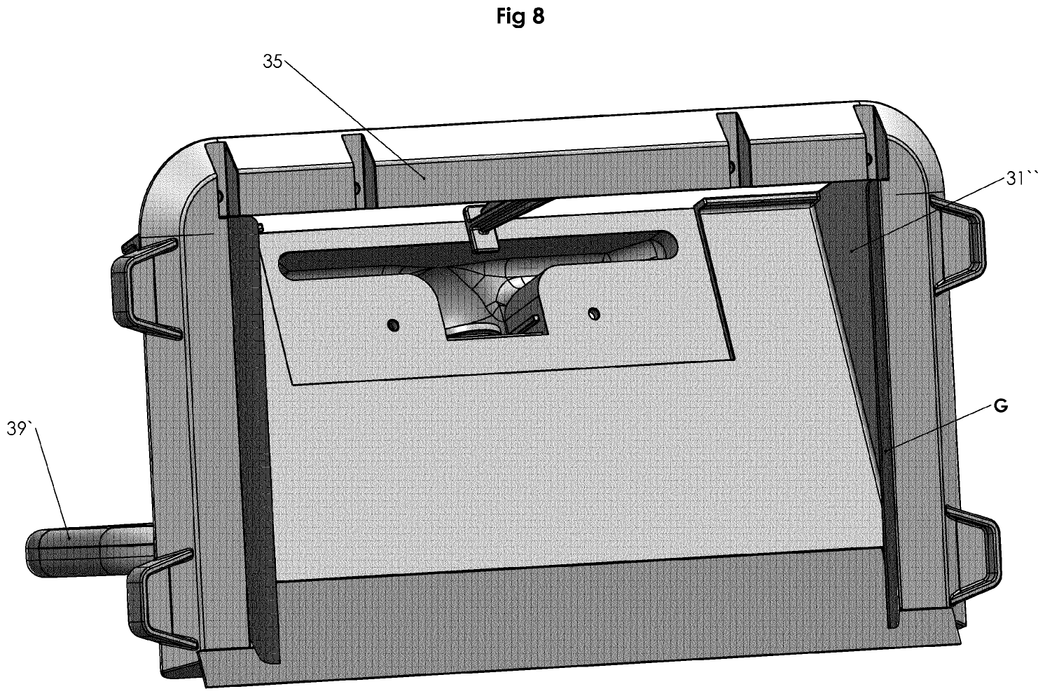

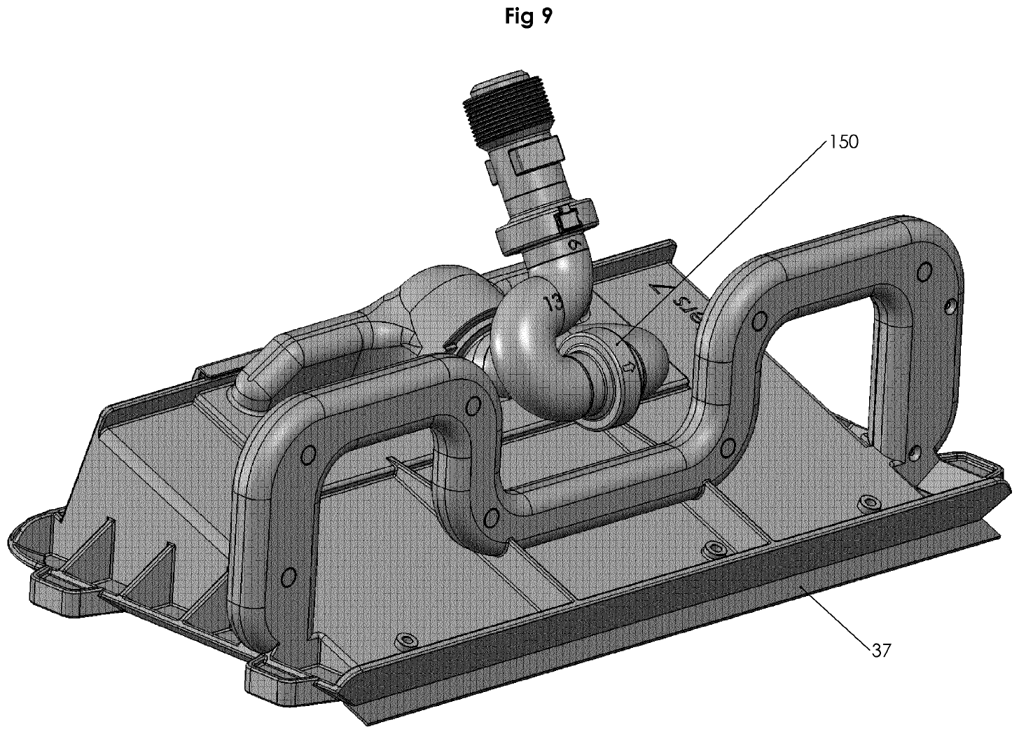

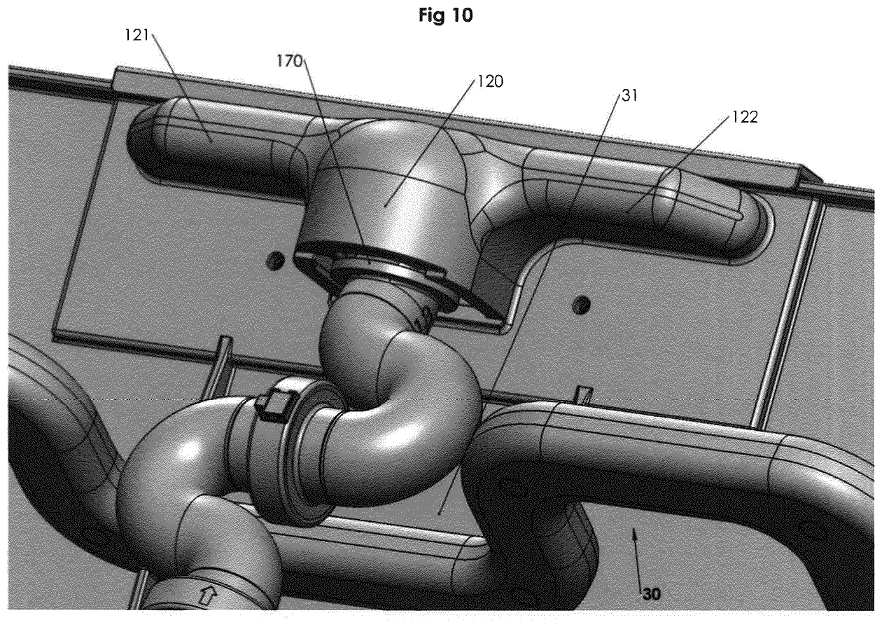

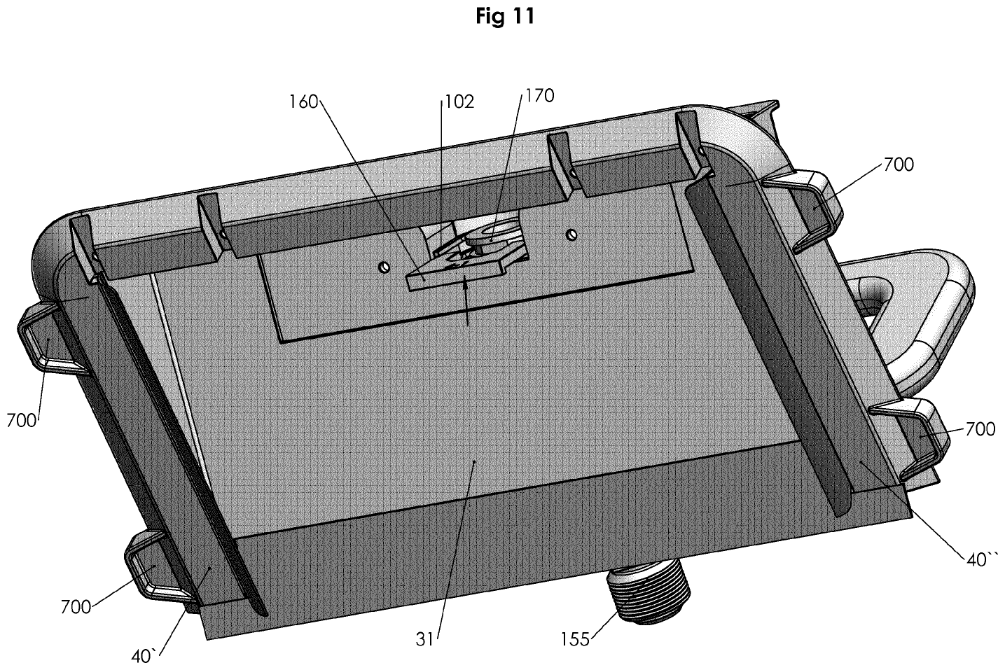

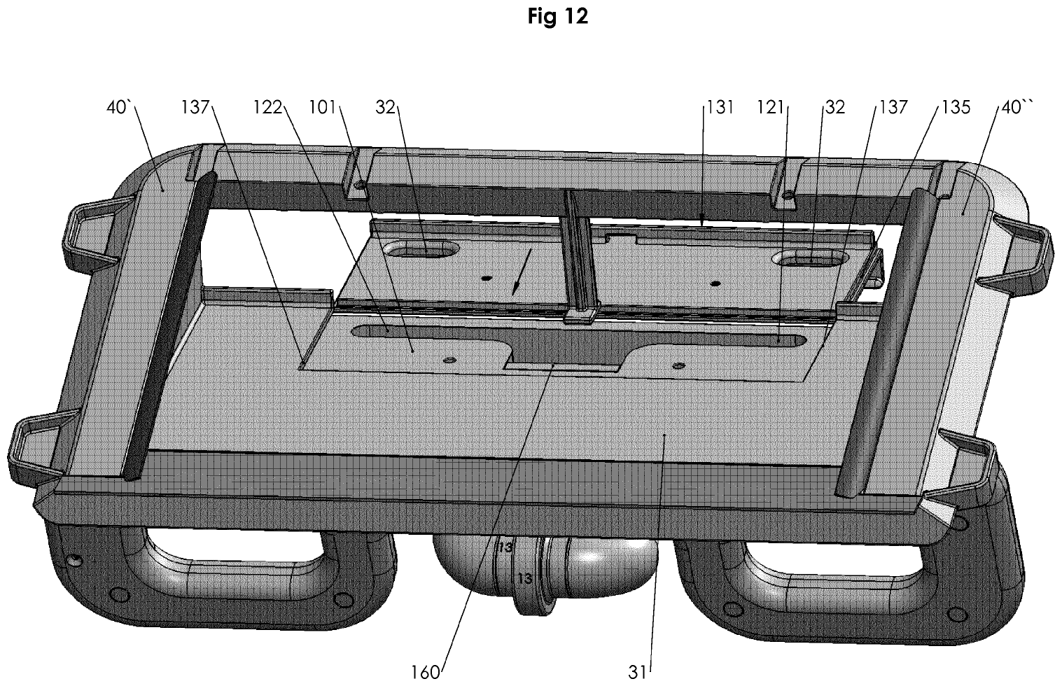

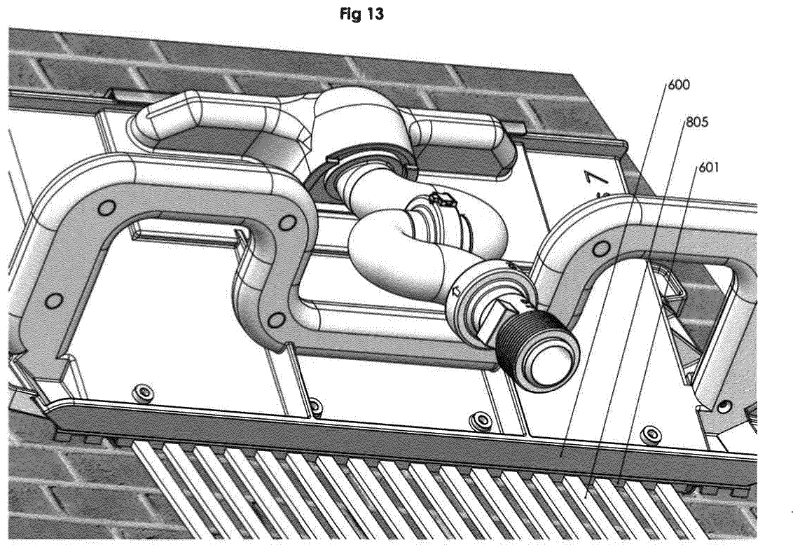

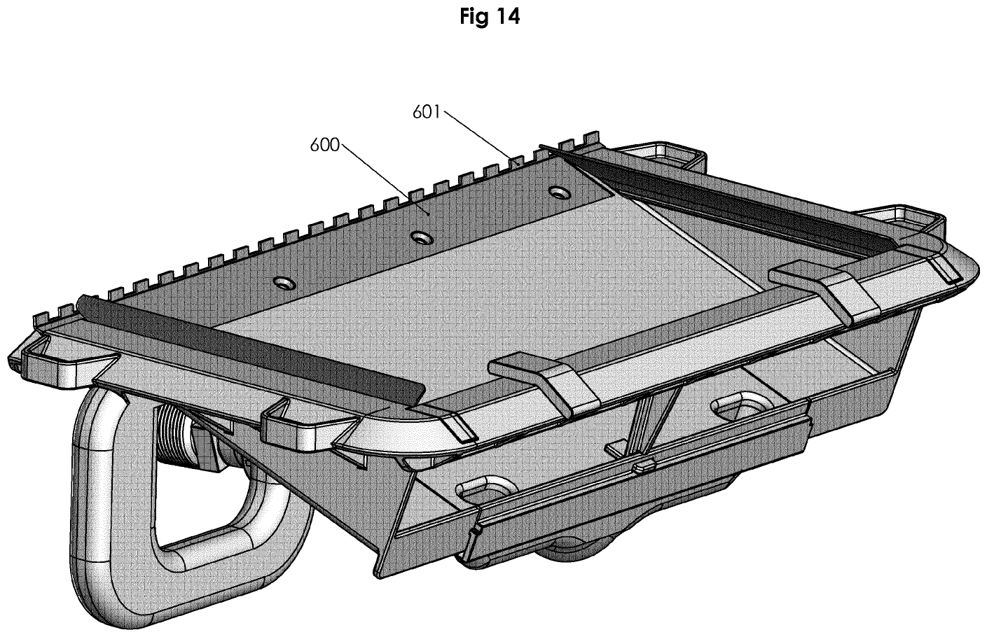

As seen in FIG. 1, preferably the hose 15 defines a first portion of the conduit while a second portion 150, seen also in FIG. 6, of the conduit serves for connecting the hose 15 to the mouthpiece 30. The mouthpiece 30 has a flow passage 120 for the plaster, see FIG. 5, at the entry of which passage 120 the mouthpiece 30 has a first connector 160 for connection with a second connector 170 mounted to the second portion 150 of the conduit. In itself the second portion 150 of the conduit may include two swivel joints 180, 190 configured for rotation about a first axis and a second axis, respectively; at least one swivel joint 180 defining a first axis of rotation A2 is preferred, this axis A2 being shown in FIG. 6 and extending parallel with, or essentially parallel with, the lower edge 37 of the rear wall 31. The second portion 150 of the conduit will be described in details further below.

Plaster preferably enters the aforementioned chamber 8′ via a bifurcation with two branches 121, 122 of the flow passage 120, through two entry openings 32. It may be understood that in operation the chamber 8′ is normally filled with a fresh mass of plaster (not shown in FIG. 2), a portion of this mass closest to the building wall 1 being normally in the process of bonding to the surface of the building wall 1. In operation the worker grips firmly onto the handle 39 to carry the mouthpiece with plaster in the chamber 8′, and moves the mouthpiece 30 upwards against the wall 1 to discharge an amount of plaster at the bottom portion B thereof, the pump 20 and the speed with which the mouthpiece 30 is moved manually upwardly along the wall 1 preferably being adjusted to maintain the level of plaster material in the chamber 8′ corresponding essentially to the level of the inspection opening 36, or to any other selected level within the chamber 8′. Preferably the pump 20 is started to supply a predetermined constant amount of plaster per unit time, and the upward movement of the mouthpiece is adjusted as explained. It will be understood that the mouthpiece 30 as such has the outwardly open recess 8, as best seen in FIG. 3, which defines the aforementioned chamber 8′ when the mouthpiece 30 is placed against the building wall 1, and coating material is discharged to/deposited onto an area of the building wall corresponding substantially to the length of the chamber 8′ in the direction between the opposite side walls 31′, 31″, the chamber 8′ being delimited at the bottom portion B along its length by the lower edge 37 of the rear wall 31.

As seen in FIGS. 3 and 4 the two opposite side walls 31′, 31″ each preferably include a flange, in the following referred to as first flange 34′ and second flange 34″. The flanges 34′, 34″ are oriented away from the recess 8 and have respective surfaces SF, normally only at the top portion T of the mouthpiece 30, pressed directly against the building wall 1 by the worker in use of the machine. Preferably, as shown, the flanges 34′, 34″ each support at least one device 40′, 40″, referred to in the following as a “spacer device”, to be discussed below, which slides against the building surface in use of the plastering machine 10 and which has the surface SF being pressed directly against the building wall 1. Often the extension of the surfaces SF in the direction of the lower edge 37 and perpendicularly thereto will be selected to be greater than the width of any vertical mortar joints between bricks forming the wall 1.

The spacer devices 40′, 40″ are preferably releasably connected to the respective flange 34′, 34″, in the shown embodiment by screws or, alternatively, such as by a snap connection, or by other complementary coupling elements. The spacer devices 40′, 40″ may be replaced when worn down. Sideways leakage of plaster material from the chamber 8′ is prevented or restricted by a respective elongated flexible seal 300, preferably of rubber or similar material, connected to each side wall 31′, 31″ and extending between the bottom portion B and the top portion T. Together with the faces SF, the flexible seal 300 and the lower edge 37 are placed against the building surface 1 when applying the coating material in the recess 8. The flexibility of the seals 300 allows the mouthpiece 30 to follow the surface contour of the building wall 1, with the lower edge 37 remaining in contact therewith, such that variations in the coating thickness are largely avoided. The flexible seal 300 is illustrated as being of a blade structure, preferably with a thicker edge portion inserted into a respective groove G along the side walls 31′, 31″, as shown in FIG. 8 which also shows similar, optional grooves for receiving a respective spacer 40′, 40″ as well as a shallow recess for receiving a separate, replaceable part defining or including the lower edge 37, as discussed above. Preferably, as seen best in FIGS. 3 and 4, the flexible seal 300 has a first surface 304 and an opposite second surface 302, the first surface 304 being oriented towards the material contained in the recess 8 when the flexible seal 300 is placed against the building surface/wall 1 in use of the machine 10. In this manner a self-sealing effect is achieved in that the material in the recess 8/chamber 8′ presses the second surface 302 against the building surface 1.

The aforementioned second portion 150 of the conduit will now be described in details with reference to FIG. 6. As shown, the second portion 150 includes two subparts referenced in the cross-sectional view of FIG. 7 by numerals 152 and 156, respectively, and defining an internal flow passage through which coating material is supplied to the mouthpiece 30. As discussed above the mouthpiece 30 has a first connector 160 which is connected to a second connector 170 which in the shown embodiment is integral with the subpart 152.

Each subpart 152, 156 has a shape preferably resembling the body of a question-mark; thus, subpart 152 has a straight section 153 contiguous with a U-shaped section 151 while subpart 156 has a U-shaped section 158 contiguous with a straight section 155 having a portion 156 which is treaded or otherwise configured for being connected to one end of the flexible (bendable) hose that defines the first portion 15 of the conduit joining the mouthpiece 30 with the coating material supply 20. The two U-shaped sections 151, 158 are rotatably connected at swivel joint 180, such as through a ring-structure engaging flanges 154 at the respective ends of the U-shaped-sections, with an O-ring (not shown) provided as required to establish a seal. Alternatively, as shown, each of the flanges 154 may have annular recesses formed in opposed wall portions, whereby the two U-shaped sections 151, 158 are held together by filling, via a filling opening in one or both of the flanges 154, an annular groove defined by the opposed recesses with metal or other material bearing balls 182. In this manner rotation about a swivel axis A2 of the two subparts 152, 156 relative to one another is enabled, whereby the mouthpiece 30 may be applied against the building wall 1 near the base with the subpart 156 rotated outwards, as illustrated in FIGS. 5 and 9, reducing the risk of kinking of the flexible hose had it been connected directly with the mouthpiece 30.

As shown in FIGS. 5 and 9, through the shape of the two U-shaped sections 151, 158 the second portion 150 may be back-folded to some extent when the two subparts 152, 156 are rotated relative to one another, without blocking the flow of plaster through the conduit. Preferably, as shown in FIG. 6 the two straight sections 153, 155 extend generally in a common plane perpendicular to the plane of the paper; however, within this common plane the straight section 153 of the subpart 152 connected to the mouthpiece 30 preferably extends at an angle to the U-shaped section 151, i.e. such that an angle is defined in the aforementioned plane between the respective longitudinal axes A1 and A3 of the two straight sections 155, 153. This allows the straight section 153 to extend parallel with the inclined rear wall 31 of the mouthpiece 30, with the remaining part of the second portion 150 extending essentially in a vertical plane when in the configuration shown in FIGS. 1 and 2.

Preferably, for added flexibility the second portion 150 of the conduit also is structured to include a second swivel joint 190 to allow for a relative rotation between parts of the second portion 150 about another axis A1, such as the aforementioned longitudinal axis A1 of the straight section 155, perpendicular to the swivel axis A2 of the first swivel joint 180. The second swivel joint 190 may be a structural part of the second portion 150, such as by being configured as a rotatable connection between U-shaped section 158 and straight section 155 of subpart 156; alternatively, the second swivel joint 190 may be defined through the connection between the first and second connectors 160, 170, i.e. where the second portion 150 of the conduit is connected to the mouthpiece 39.

Connection between the first and second connector 160, 170 will now be discussed in further details with reference to FIG. 10 and onwards. FIG. 10 shows structural portions of the two branches 121, 122 of the flow passage 120 of the mouthpiece 30, and illustrates the connector 170 of the second portion 150 of the conduit being inserted into the flow passage 120, for subsequent connection therewith by the second connector 170 engaging the first connector 160 seen in FIG. 11. A recess 101 formed in the rear wall 31, see FIG. 12, defines faces of the aforementioned structural portions of the two branches 121, 122 as well as a groove 102 (see FIG. 11, wherein the perspective does not allow the branches 121, 122 to be seen) for receiving the first connector 160 shown here as a slidable fork-like member with two legs thereof being inserted at the same time in the direction of the arrow into a peripheral groove 171 of the second connector 170, see FIG. 6. This provides for a reliable and releasable securing of the second portion 150 of the conduit to the mouthpiece 30, useful for eg. cleaning the mouthpiece.

FIG. 12 shows a subsequent step wherein after full insertion of the first connector 160 into the groove 102 a plate-like member 131 is slid along the direction of the arrow in opposite tracks defined also along the recess 101. Sliding this plate-like member 131 into its final position seen in FIG. 3 completes the mounting of the second portion 150 of the conduit to the mouthpiece 30 while at the same time defining together with the recess 101 the two branches 121, 122.

FIGS. 13 and 14 show an embodiment of the mouthpiece 30 wherein the lower edge 37 is serrated, i.e. having teeth, FIG. 13 showing the pattern of a coating material, which may be glue, deposited on the building surface 1 using such a mouthpiece. Preferably the serrations are formed in a metal replacement part 600 as discussed above. This embodiment is of advantage where a board, such as a gypsum board, is to be mounted onto the building surface 1, the serrations providing a saving in the coating material.

As seen, the handle 39 preferably has gripping portions 39′, 39″ around which a worker may grip with the fingers of his hand. Each gripping portion 39′, 39″ is preferably arranged adjacent, preferably alongside, a respective one of the side walls 31′, 31″, with the gripping portions 39′, 39″ each being for a user to grip around, preferably all around, with his hand and each being rigidly connected to either the flanges 34, 34″ or to the opposite side walls 31′, 31″. For the shown embodiment the handle 39 loops inwardly towards the rear wall 31 with the two gripping portions 39′, 39″ being connected for high stability while allowing the two U-shaped sections 151, 158 of the second portion 150 to be back-folded. As shown, for maximum stability and ability to press the mouthpiece against the building surface each gripping portion 39′, 39″ is connected to a respective flange 34′, 34″.

As a final note it is mentioned that the handle/mouthpiece 30 may be provided with switches/contacts as required for controlling operation of the pump 20, such as pump start/stop and/or pump speed, preferably wirelessly. Moreover, as seen in the figures, distance keepers 700 may be provided along one or more sides of the mouthpiece 30; this being of advantage where the mouthpiece is used for applying coating material to panels where the coating material is to be applied as runs extending at a certain distance corresponding to the dimension of the distance keepers 700 from the edges of the panels. For such uses the mouthpiece, as defined in claim 11 may be used for applying glue/binder on panels, even panels lying horizontally, onto which another panels is to be secured, such as where insulating panels are to be applied onto a concrete or other material building surface.

1. A plastering machine for applying a surface coating layer to a building surface, such as to a building wall, comprising:
a coating material supply connected to a mouthpiece via a conduit,
said mouthpiece having a top portion (T) and a bottom portion (B) and including:
a rear wall,
a first side wall and
a second side wall opposite said first side wall,
said rear wall being connected to or integral with said first side wall and said second side wall to define a coating material recess for containing coating material supplied to said mouthpiece through said conduit, said recess preferably tapering in a direction from said top portion (T) to said bottom portion (B),
said rear wall having a lower edge at said bottom portion (B),
one or more faces (SF) configured for being placed against said building surface when applying said coating material contained in said recess to said building surface,
wherein
said lower edge being configured for being placed against said building surface together with said faces (SF) in use of said machine when applying said coating material contained in said recess to said building surface, said lower edge optionally being toothed, with said teeth being placed against said building surface,
an elongated flexible seal connected to each side wall extending between said bottom portion (B) and said top portion (T), for being placed against said building surface when applying said coating material contained in said recess to said building surface.

2. The plastering machine of claim 1, at least one of said flexible seals extending between said lower edge and one of said faces (SF), preferably from said lower edge to one of said faces (SF).

3. The plastering machine according to claim 1, wherein said flexible seal is configured as a rubber blade seal with a mounting structure for releasable mounting to a respective side wall, such as in a groove (G).

4. The plastering machine according to claim 1, wherein said flexible seal has a first seal surface and an opposite second seal surface, said first seal surface being positioned to face material contained in said recess when said flexible seal is placed against said building surface in use of said machine whereby said material in said recess presses said second seal surface against said building surface.

5. The plastering machine according to claim 1, said faces (SF) being on releasable spacer devices.

6. The plastering machine according to claim 1, wherein:
said first side wall including opposite said rear wall a first flange and
said second side wall including opposite said rear wall a second flange,
said first and second flanges being oriented to extend away from said recess,
said faces (SF) being on said flanges,
optionally, also including a third flange connecting said first and second side walls at said top portion (T).

7. The plastering machine according to claim 1, including a handle having gripping portions, each gripping portion being arranged adjacent, preferably alongside, a respective one of said side walls, said gripping portions each being for a user to grip around, preferably all around, with his hand.

8. The plastering machine according to claim 7, each gripping portion being connected to a respective side wall, preferably to a respective flange.

9. The plastering machine according to claim 1, a flexible hose defining a first portion of said conduit, said rear wall having a coating material flow passage, said mouthpiece having a first connector, a second portion of said conduit having a second connector for coupling with said first connector to supply said material to said flow passage, said second portion including at least one swivel joints, preferably two swivel joints configured for rotation about a first axis and a second axis respectively, said second portion preferably including two U-shaped or substantially U-shaped section connected with each other at said at least one swivel joint.

10. The plastering machine according to claim 1, said mouthpiece defining an inspection opening at said top portion (T), for visually inspecting the level of said coating material in said recess.

11. A mouthpiece for a plastering machine for applying a surface coating layer to a surface, such as to a building wall, the machine comprising a coating material supply connected to a mouthpiece via a conduit,
said mouthpiece having a top portion (T) and a bottom portion (B) and including:
a rear wall,
a first side wall and
a second side wall opposite said first side wall,
said rear wall being connected to or integral with said first side wall and said second side wall to define a coating material recess for containing coating material supplied to said mouthpiece through said conduit, said recess preferably tapering in a direction from said top portion (T) to said bottom portion (B),
said rear wall having a lower edge at said bottom portion (B),
one or more faces (SF) configured for being placed against said surface when applying said coating material contained in said recess to said surface,
wherein
said lower edge being configured for being placed against said surface together with said faces (SF) in use of said machine when applying said coating material contained in said recess to said surface,
an elongated flexible seal connected to each side wall extending between said bottom portion (B) and said top portion (T), for being placed against said surface when applying said coating material contained in said recess to said surface.

12. The mouthpiece of claim 11, at least one of said flexible seals extending between said lower edge and one of said faces (SF), preferably from said lower edge to one of said faces (SF).

13. The mouthpiece according to claim 11, wherein said flexible seal is configured as a rubber blade seal with a mounting structure for releasable mounting to a respective side wall, such as in a groove (G).

14. The mouthpiece according to claim 11, wherein said flexible seal has a first seal surface and an opposite second seal surface, said first seal surface being positioned to face material contained in said recess when said flexible seal is placed against said surface in use of said machine whereby said material in said recess presses said second seal surface against said surface.

15. The mouthpiece according to claim 11, said faces (SF) being on releasable spacer devices.

16. The plastering machine according to claim 2, wherein said flexible seal is configured as a rubber blade seal with a mounting structure for releasable mounting to a respective side wall, such as in a groove (G).

17. The plastering machine according to claim 2, wherein said flexible seal has a first seal surface and an opposite second seal surface, said first seal surface being positioned to face material contained in said recess when said flexible seal is placed against said building surface in use of said machine whereby said material in said recess presses said second seal surface against said building surface.

18. The plastering machine according to claim 2, said faces (SF) being on releasable spacer devices.

19. The plastering machine according to claim 2, wherein:
said first side wall including opposite said rear wall a first flange and
said second side wall including opposite said rear wall a second flange,
said first and second flanges being oriented to extend away from said recess,
said faces (SF) being on said flanges,
optionally, also including a third flange connecting said first and second side walls at said top portion (T).

20. The plastering machine according to claim 2, including a handle having gripping portions, each gripping portion being arranged adjacent, preferably alongside, a respective one of said side walls, said gripping portions each being for a user to grip around, preferably all around, with his hand.
